(19) United States
(12) Patent Application Publication
(10) Pub. No.: US 2017/0023847 A1
(43) Pub. Date: Jan. 26, 2017

(54) SOUND BLIMP

(71) Applicant: Mark Howard Jacobson, Sherman Oaks, CA (US)

(72) Inventor: Mark Howard Jacobson, Sherman Oaks, CA (US)

(21) Appl. No.: 15/217,906

(22) Filed: Jul. 22, 2016

Related U.S. Application Data
(60) Provisional application No. 62/195,721, filed on Jul. 22, 2015.

(51) Int. Cl. G03B 17/10; G03B 17/38

(52) U.S. Cl. CPC G03B 17/10; G03B 17/38

(57) ABSTRACT

The present disclosure is directed to a housing for operating a camera having a lens and a camera body. The housing includes a main portion defining a cavity for receiving the camera body, wherein the main portion has a front wall and a rear opening, and a closure portion releasably connected to the main portion to close the rear opening. The front wall has a lens opening for receiving the camera lens when the camera is within the cavity of the main portion, and the housing includes a homogeneous mass of rubber material.

### CROSS-REFERENCE TO RELATED APPLICATION(S)

This application claims priority to and the benefit of U.S. Provisional Patent Application No. 62/195,721, filed on Jul. 22, 2015 in the United States Patent and Trademark Office, the entire contents of which are incorporated herein by reference.

### BACKGROUND

Many cameras, such as single lens reflex (or SLR) cameras, include a camera body, a lens, a viewfinder, a data display, and a shutter release that actuates movement of a shutter. When taking a photo, the shutter emits a sound, such as a “click.”

Oftentimes, a still camera will be used during filming (or recording) of a motion picture or television show. However, the sound emitted from the shutter of the still camera may be picked up by the sensitive audio equipment used during filming, which can result in the need for reshoots or audio dubbing because of the sound captured on the soundtrack of the motion picture or television show. Accordingly, a need developed for the use of a housing or case that reduces the sound emitted from the camera shutter by enclosing the camera. Housings of this type are sometimes referred to as “sound blimps.”

Although sound blimps have been known in the art since the mid-1960s, the sound blimps of the prior art are often made of metal, sometimes requiring multiple layers, which resulted in an expensive to manufacture and heavy design. Prior art sound blimps also would typically require the use of a remote control to actuate the shutter release button. Further, the prior art sound blimp did not provide any means for using features on the camera other than the shutter release or autofocus because additional openings in the sound blimp would diminish the sound dampening properties of the sound blimp.

### SUMMARY

One or more aspects of the present disclosure include a housing for operating a camera that is made of a lightweight rubber or rubber-like material. One or more aspects of the present disclosure are directed to a housing that allows a user to use various features of the camera without compromising or significantly compromising sound dampening qualities.

According to one or more embodiments, a housing for operating a camera having a lens and a camera body includes a main portion defining a cavity for receiving the camera body, wherein the main portion has a front wall and a rear opening, and a closure portion releasably connected to the main portion to close the rear opening. The front wall has a lens opening for receiving the camera lens when the camera is within the cavity of the main portion, and the housing includes a homogeneous mass of rubber having a thickness of at least ⅛ inch.

In some embodiments, the housing has a glassy transition temperature of between about −43 C and about −73 C.

In more detailed embodiments, the front wall has a thickness of at least ⅛ inch.

In some embodiments, the front wall has a thickness of between about ¼ inch and about ½ inch.

In some embodiments, the thickness of the front wall is ⅜ inch.

In some embodiments, the material of the housing is an ethylene propylene diene monomer (EPDM) rubber.

In some embodiments, the closure portion includes a closure wall and an edge portion extending around the perimeter of the closure wall and away from the closure wall in a direction perpendicular to the closure wall.

In some embodiments, the main portion includes a top wall, a bottom wall, and two side walls, each including a first profiled edge portion, and the peripheral portion of the closure wall includes a second profiled edge portion, wherein the first profiled edge portion is complementary to the second profiled edge portion.

In some embodiments, one of the first and second profiled edge portions is a rib and the other of the first and second profiled edge portions is a groove.

In some embodiments, the bottom wall has a thickness of ½ inch.

In some embodiments, the main portion and the closure portion are connected by a hinge.

In some embodiments, the hinge is recessed into the housing.

In some embodiments, the housing further includes a recess in a bottom surface of the housing.

In some embodiments, the recess includes a threaded opening.

In some embodiments, the housing further includes a non-axisymmetric threaded adapter sized to fit inside the recess of the housing.

In some embodiments, the housing further includes a flange surrounding the lens opening and extending away from the housing.

In some embodiments, the flange includes a notch in a lower portion thereof.

In some embodiments, the housing further includes one or more retainers connected to the flange and configured to maintain contact between a lens tube and the flange.

In some embodiments, the main portion further includes a shutter through-hole and the housing further includes a shutter button configured to engage a shutter release on the camera.

In some embodiments, the closure wall further includes a first protrusion protruding from an inner surface of the closure wall to engage a first button on the camera body when the camera is in the housing and when the rear opening is closed.

In some embodiments, the closure wall further includes a second protrusion protruding from an inner surface of the closure wall to engage a second button on the camera body when the camera is in the housing and when the rear opening is closed.

In some embodiments, a portion of the closure wall surrounding the first protrusion is thinner than adjacent portions of the closure wall.

In some embodiments, the portion of the closure wall surrounding the first protrusion is a first protrusion groove.

In some embodiments, the main portion includes a top wall having a utility bar connected thereto.

In some embodiments, the utility bar comprises a plurality of shoes for mounting accessories to the housing.

In some embodiments, the main portion includes a slidable side panel that is removable to expose a side of the camera body when the camera is in the housing and when the rear opening is closed.

### BRIEF DESCRIPTION OF THE DRAWINGS

These and other features and aspects of embodiments of the present disclosure will be better understood by reference to the following detailed description, when considered in conjunction with the accompanying drawings. Like numbers are used throughout the figures to reference like features and components.

FIG. 1 is a perspective view of a housing accommodating a camera according to one or more exemplary embodiments of the present disclosure.

FIG. 2 is a perspective view of a housing accommodating a camera and in an open configuration according to one or more exemplary embodiments of the present disclosure.

FIG. 3 is a back view of the housing of FIG. 2 in the open configuration.

FIG. 4 is a perspective view of a housing according to one or more exemplary embodiments of the present disclosure.

FIG. 5 is a back elevation view of the housing of FIG. 4 in a closed configuration.

FIG. 6 is a side view of the housing of FIG. 5 in the closed configuration.

FIG. 7 is a top view of a housing and a lens hood according to one or more exemplary embodiments of the present disclosure.

FIG. 8 is a bottom view of a housing according to one or more exemplary embodiments of the present disclosure.

FIG. 9 is a view of an inner surface of a closure wall of a housing according to one or more exemplary embodiments of the present disclosure.

FIG. 10 is a perspective view of a cavity of a housing according to one or more exemplary embodiments of the present disclosure.

FIG. 11A is a view of a housing and a plug removed from the sound blimp according to one or more exemplary embodiments of the present disclosure.

FIG. 11B is is a view of the housing of FIG. 11A with the plug inserted into the housing according to one or more exemplary embodiments of the present disclosure.

FIG. 12A is a side view of a utility bar according to one or more embodiments of the present disclosure.

FIG. 12B is a top view of the utility bar of FIG. 12A.

FIG. 13 is a side view of a housing having a side panel in an opened configuration with the side panel removed therefrom according to one or more exemplary embodiments of the present disclosure.

### DETAILED DESCRIPTION

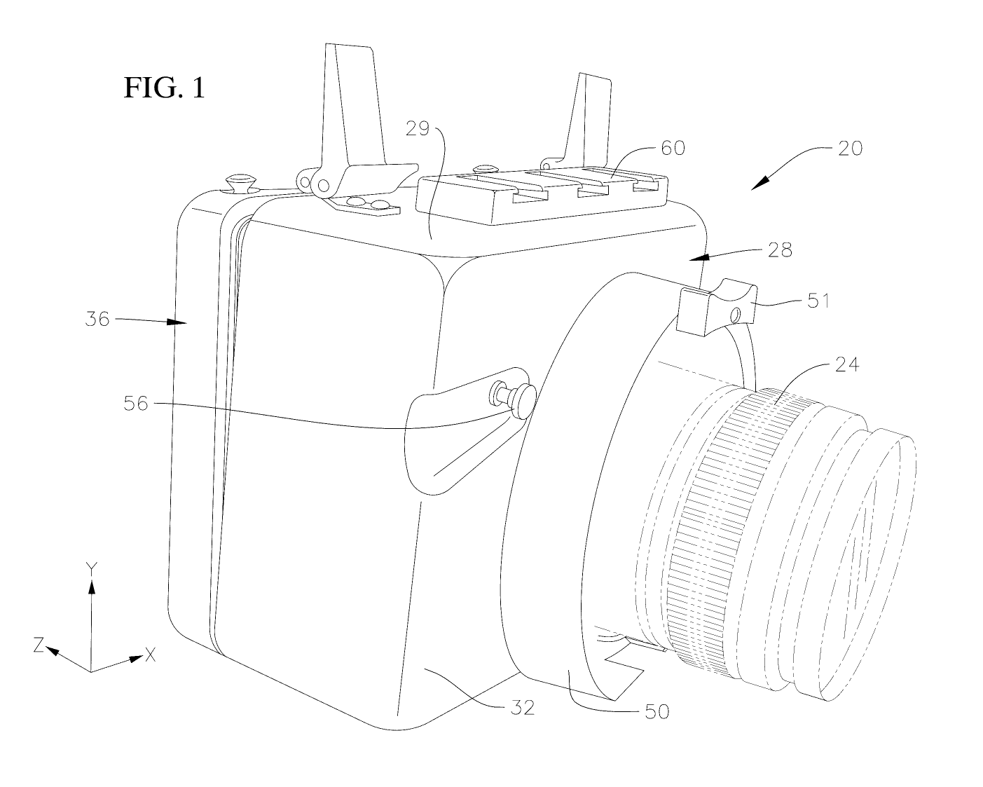

Referring now to an example embodiment illustrated in FIGS. 1-3 the present disclosure relates to a housing 20 for operating a camera 22 that provides sound dampening qualities. The camera 22 has a lens 24 and a camera body 26. The housing 20 has a main portion 28 that defines a cavity 30 and includes a front wall 32 and a rear opening 34, and has a closure portion 36 that is releasably connected to the main portion 28 and closes the rear opening 34. The cavity 30 accommodates the camera body 26. The front wall 32 has a lens opening 38 that corresponds to and exposes the lens 24. As illustrated in FIG. 1, the lens 24 may extend through the lens opening 38. The housing 20 may be made of a solid, homogeneous mass of rubber or rubber-like material. For example, the housing 20 may be made of an elastomeric material having improved vibration isolation and damping characteristics. For example, the housing 20 may have a glassy transition temperature of between about −43 C and about −73 C. As such, when the camera 22 is in the housing 20, any sound emitted from the camera 22 during operation is dampened by the housing 20.

The closure portion 36 has a closure wall 40 that is opposite to the front wall 32 when the rear opening 34 is closed. The closure wall 40 may include a first protrusion 42 that corresponds to an autofocus button, or other similar button, on the camera body 26. As such, when a user applies pressure to the closure wall 40 in the area of the first protrusion 42, the first protrusion 42 may engage the autofocus button, or other similar button. The closure wall 40 may include a second protrusion 44 that corresponds to a navigation button, or other similar button, on the camera body 26. As such, when a user applies pressure to the closure wall 40 in the area of the second protrusion 44, the second protrusion 44 may engage the navigation button, or other similar button. The closure wall 40 may include a viewfinder window 46 and may include a screen window 48. The viewfinder window 46 aligns with a viewfinder on the camera body 26 and the screen window 48 aligns with a screen, for example an LCD panel, on the camera body 26.

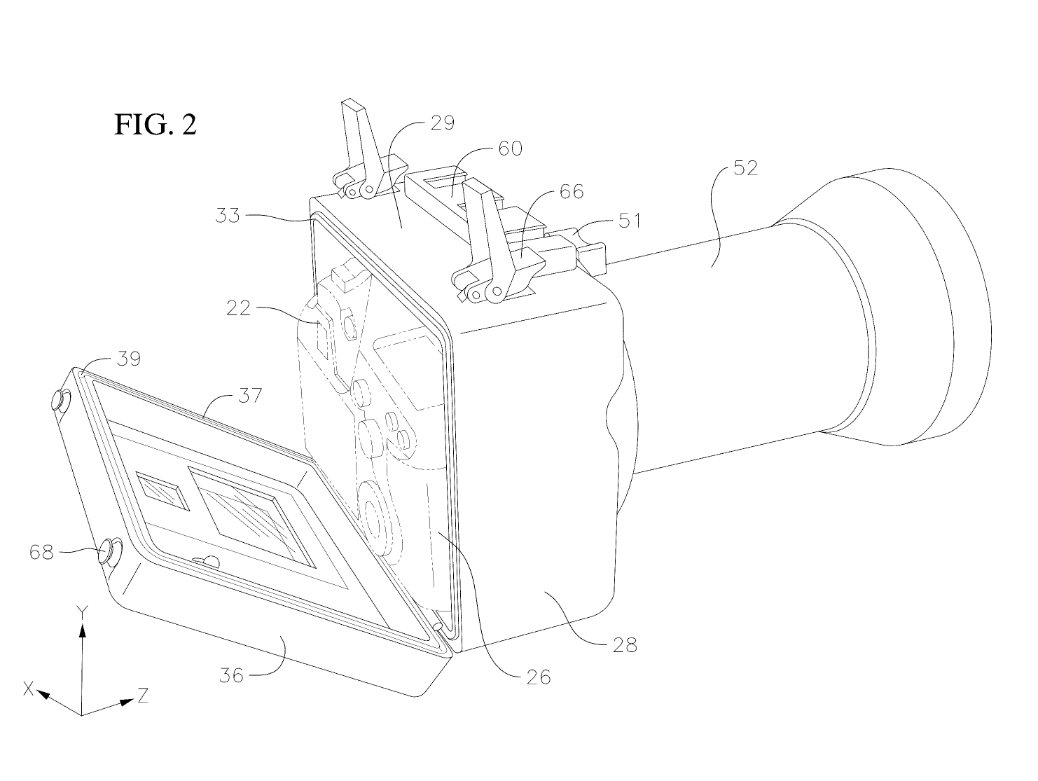

The front wall 32 may include a flange 50 (e.g., a lens tube flange) that corresponds to the lens opening 38. The flange 50 may be configured to receive a lens cover or a lens hood or a lens tube 52, as illustrated in FIG. 2. The flange may include a notch 54 at a lower portion of the flange 50. The notch 54 may prevent or substantially prevent the flange 50 from extending beyond a bottom surface of the housing 20 so that the housing 20 may sit level on a flat surface. The front wall 32 may include a shutter trigger assembly 56 (e.g., a shutter button) that corresponds to a shutter release on the camera body 26, such that when a user depresses the shutter trigger assembly 56, a shaft 58 of the shutter trigger assembly 56 engages the shutter release.

The main portion 28 may also include a utility bar 60. The utility bar 60 may be mounted on a top wall 29 of the main portion 28, and may include one or more shoes 62 that are configured to hold various camera accessories, for example, a lens shade, a French Flag, a GOPRO camera, etc.

The housing 20 may be adapted to be mounted on a tripod. The housing 20 may include a removable side panel 64 (e.g., a side access panel) that may expose a side of the camera body 26. As such, a user may attach various cables to the camera body 26, such as audio/visual cables to allow a user to display images on an external screen, without removing the camera 22 from the housing 20.

The housing 20 is made of a homogeneous mass of rubber or rubber-like material. For example, the housing 20 may be made of an elastomeric material having relatively low sound damping properties and improved vibration isolation properties, such that the housing 20 has low transmissibility of sound at frequencies above the resonating frequency of the material. For example, the housing 20 may be made of a material having a relatively low ratio of viscous to elastic response and/or a relatively low glass transition temperature (Tg). If the sound emitted from the shutter of the camera 22 is at a higher frequency than the resonant frequency of the material of the housing 20, the material exhibits low transmissibility and thus the sound is dampened by the housing 20. For example, the housing 20 may be made of an elastomeric material having a Tg of −40 C or less, potentially a Tg in a range of between about −43 C and −73 C, and in one particular embodiment, a Tg of −65 C. Some examples of suitable materials include ethylene propylene diene monomer (EPDM) rubber, ethylene propylene (EPM) rubber, natural rubber (NR), and styrene butadiene rubber (SBR), but the present disclosure is not limited thereto. In one or more embodiments, the housing 20 is made of EPDM rubber. In one or more embodiments, the housing 20 is made of a thermosetting elastomer.

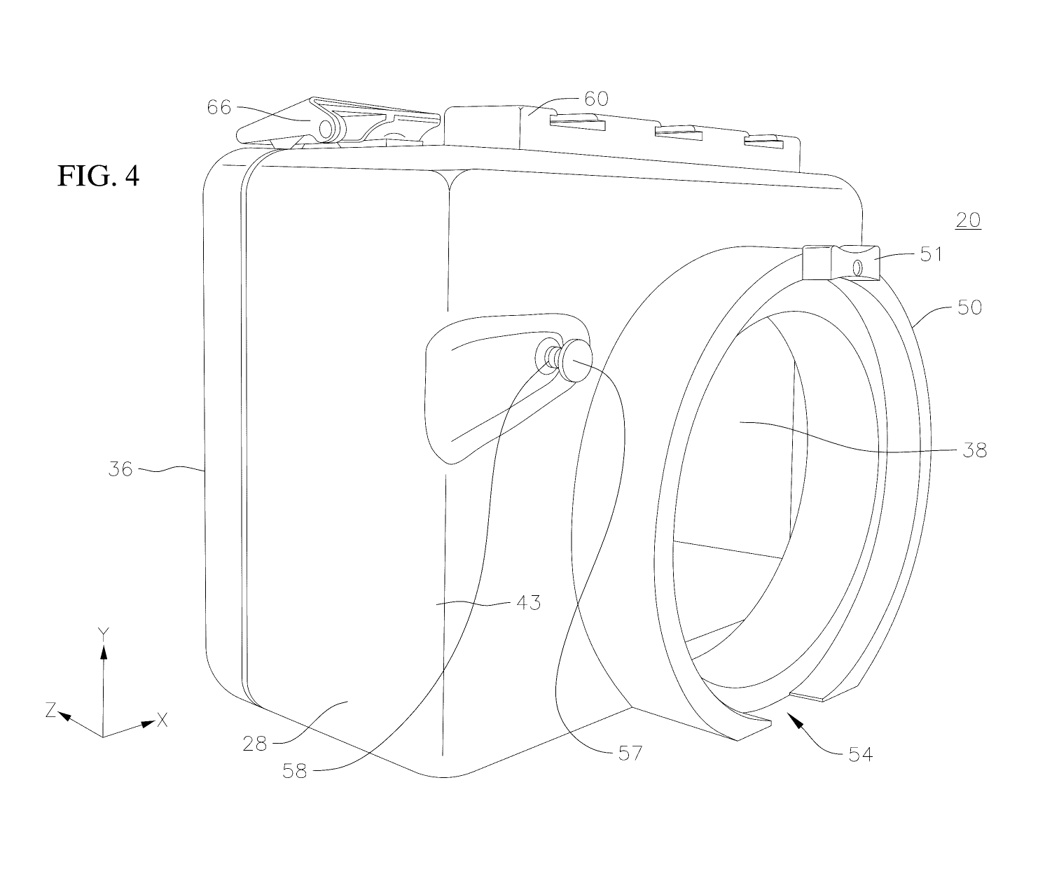

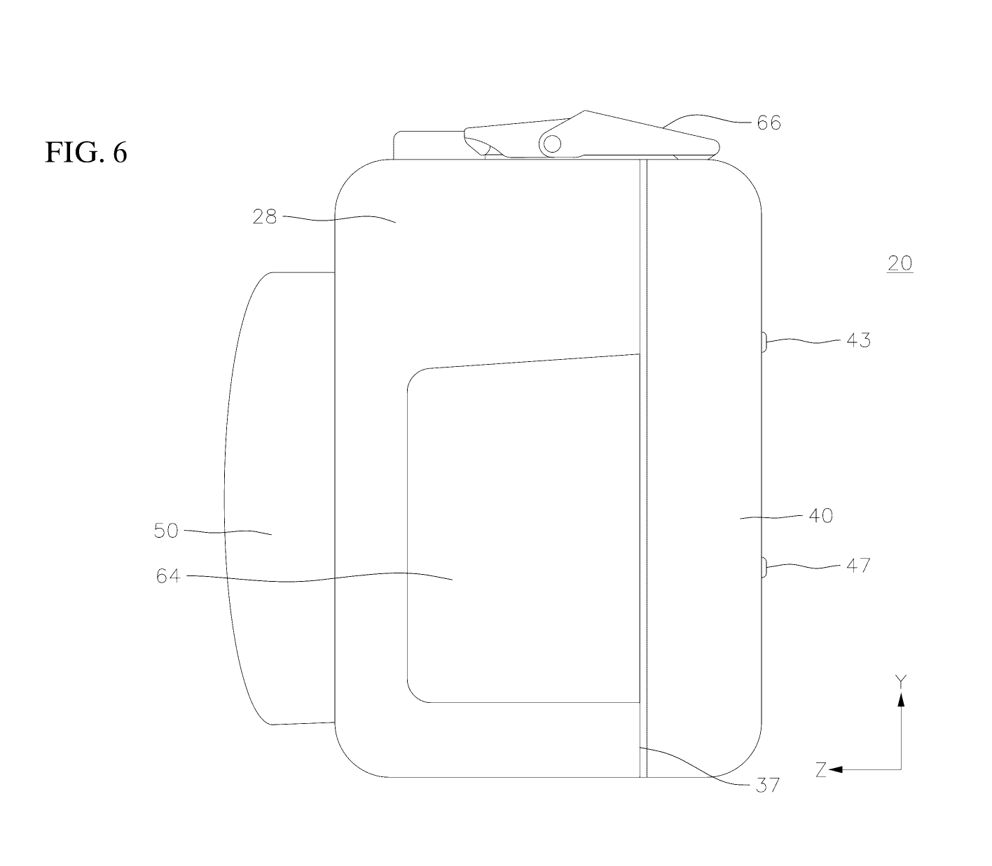

Referring now to an example embodiment illustrated in FIGS. 4-10, the housing 20 includes the main portion 28 and the closure portion 36. The main portion 28 may include the front wall 32, a top wall 29, a bottom wall 31, a first side wall, a second side wall, and the rear opening 34. The front wall 32 may extend in a first direction X and a second direction Y and may have a depth (or a thickness) in a third direction Z, perpendicular to the first direction X and the second direction Y. The main portion 28 may have a generally quadrilateral hexahedral shape, such that five faces of the hexahedron are made of the elastomeric material and the sixth face of the hexahedron is defined by the rear opening 34. The main portion 28 may also define the cavity 30, which accommodates the camera 22 (e.g., the camera body 26). The camera 22 may be inserted into the cavity 30 through the rear opening 34. As discussed further below, the closure portion 36 includes the closure wall 40.

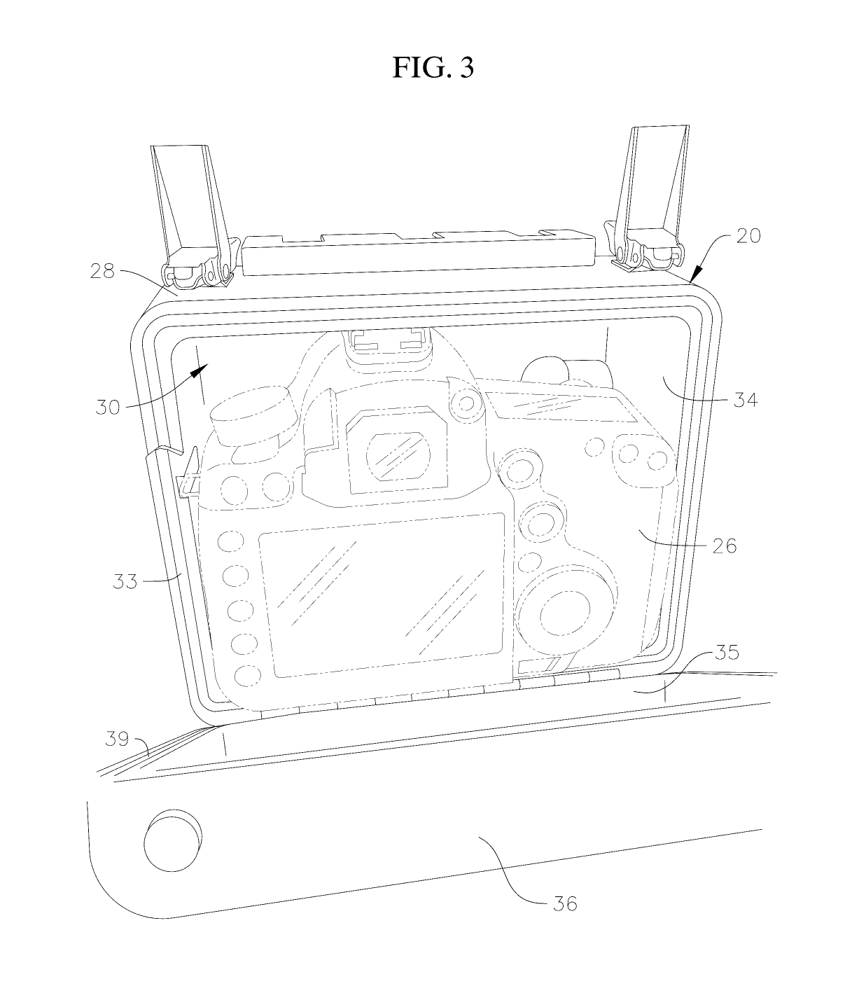

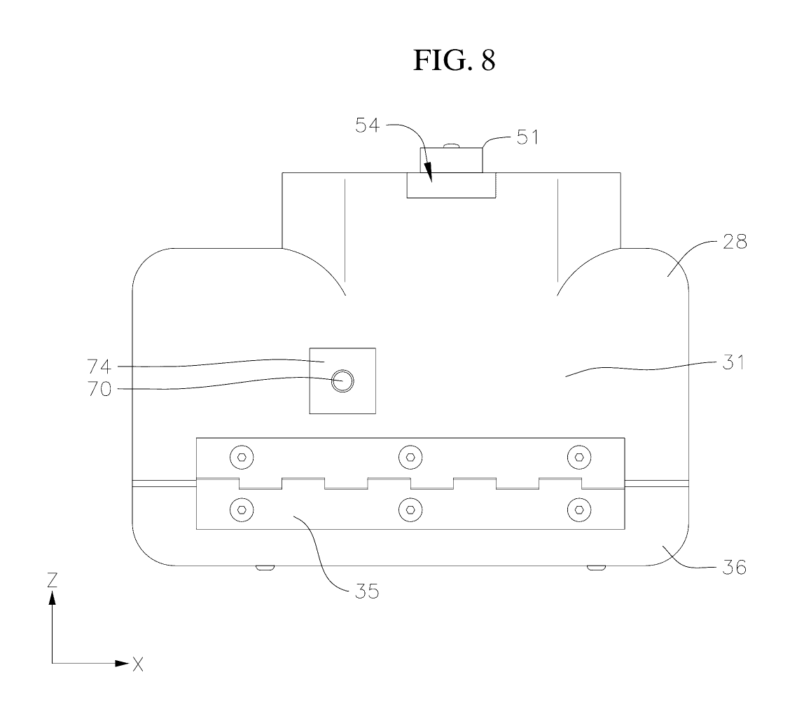

The housing 20 is movable between a closed configuration, illustrated in FIG. 4, where the closure wall 40 and the front wall 32 are opposing each other and are in parallel, and an open configuration, illustrated in FIGS. 2 and 3, as enabled by a hinge 35 (illustrated in FIG. 8), where the closure portion 36 is pivoted about the hinge 35 and the cavity 30 is exposed.

The closure portion 36 includes the closure wall 40 (i.e., a rear wall of the housing 20). The closure wall 40 may have a substantially rectangular face. The closure portion 36 may further include an edge portion or a peripheral portion 37 that may extend along the entire perimeter of the closure wall 40, and may extend away from the face of the closure wall 40 in a direction perpendicular to the closure wall 40. For example, when the housing 20 is in the closed configuration, the substantially rectangular closure wall 40 may extend in the first direction X and the second direction Y, and the edge portion 37 may extend in the third direction Z. In one or more embodiments, the main portion 28 and the closure portion 36 may have rounded or beveled edges, as illustrated in FIGS. 4-10. As such, when the housing 20 is in the closed configuration, the edge portion 37 abuts the top wall 29, the bottom wall 31, the first side wall, and the second side wall.

In one or more embodiments, the housing 20 may have a uniform or substantially uniform thickness. In other words, each wall of the main portion 28 and the closure portion 36 may have the same thickness. In other embodiments, the thicknesses of the walls of the housing 20 may vary. For example, in one or more embodiments, the thickness of the top wall 29 may be greater than the thickness of the bottom wall 31. The thickness of the edge portion 37 may vary according to the thickness of the walls of the main portion 28. For example, in embodiments where the thickness of the top wall 29 is greater than the thickness of the bottom wall 31, a thickness of a top portion of the edge portion 37 will be greater than a thickness of a bottom portion of the edge portion 37. In one or more embodiments, the thickness of the housing 20 may range from between about ¼ inch to about 1 inch, preferably between about ⅜ inch to ⅝ inch, and more preferably between about ⅜ inch and about ½ inch. In one or more embodiments, the thickness of the bottom wall 31 may range from between about ¼ inch to about 1 inch, preferably between about ⅜ inch to ⅝ inch, and more preferably about ½ inch, and the thickness of the front wall may range from about ⅛ inch to about ¾ inch, preferably between about ¼ inch to about ⅝ inch, and more preferably about ⅜ inch.

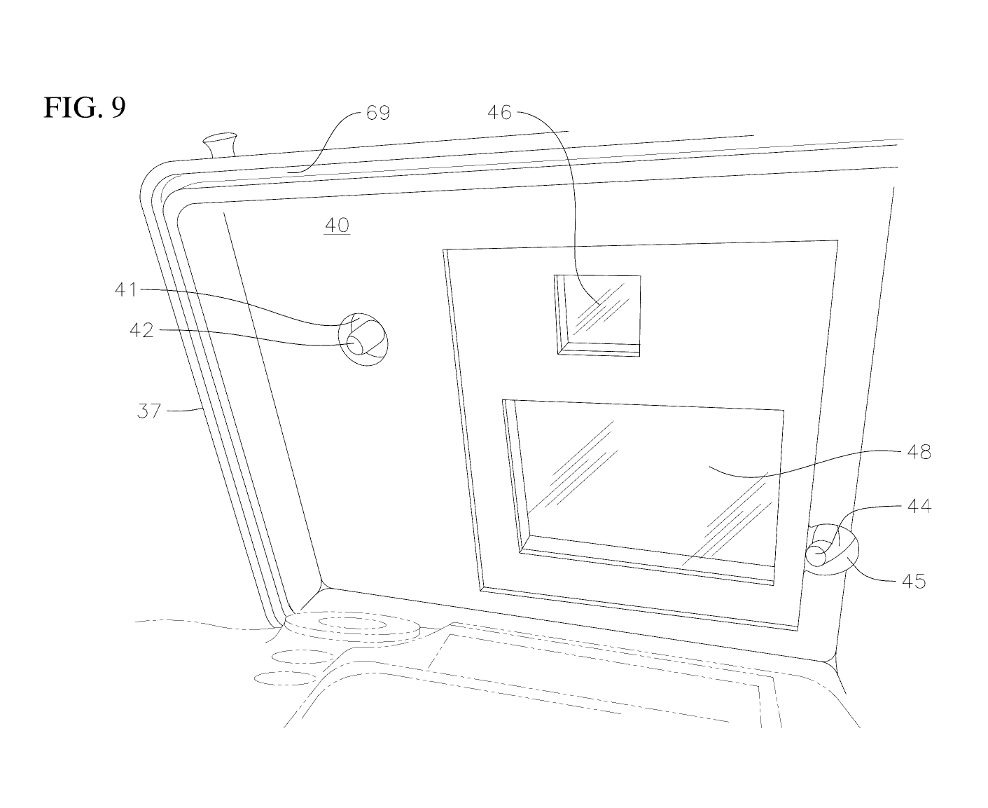

As discussed above, the housing 20 provides sound dampening qualities. In order to minimize or reduce the amount of sound that escapes from the housing 20, the main portion 28 and the closure portion 36 may be sealed together when in the closed configuration. Referring to FIGS. 3 and 9, in one or more embodiments, the top wall 29, the bottom wall 31, and the first and second side walls of the main portion 28 may together form a first profiled edge portion. Similarly, the closure portion 36 may include a peripheral portion that extends around the perimeter of the closure wall 40 and away from the closure wall 40 in a direction perpendicular to the closure wall. The peripheral portion may include a second profiled edge portion. The first profiled edge portion and the second profiled edge portion are complementary to each other. For example, the first profiled edge portion may be a rib 33 and the second profiled edge portion may be a groove 39. When the housing 20 is in the closed configuration, the rib 33 may be fitted inside of the groove 39, forming a seal between the main portion 28 and the closure portion 36. As such, the main portion 28 and the closure portion 36 may be securely closed, and the likelihood of any gaps forming between the main portion 28 and the closure portion 36 is minimized. Thus, the housing 20 may exhibit improved sound dampening qualities because the main portion 28 and the closure portion 36 are sealed together. Further, the housing 20 may substantially isolate the camera 22 from outside elements, such as wind, rain, or sand because the main portion 28 and the closure portion 36 are sealed together. In some embodiments, the first profiled edge portion may be the groove 39 and the second profiled edge portion may be the rib 33.

In some embodiments, the housing 20 may omit the groove 39 and the rib 33. In some embodiments, the rib 33 and the groove 39 may be discontinuous, or may extend around only a portion of the corresponding first and second profiled edge portions. For example, the rib 33 may extend from the top wall 29, and the first and second side walls of the main portion and the groove 39 may extend along top and side portions of the edge portion 37, but not along the bottom portion of the edge portion 37.

The main portion 28 and the closure portion 36 may be attached together, thereby substantially enclosing the cavity 30 and covering the rear opening 34, and the main portion 28 and the closure portion 36 may be separated or substantially separated, thereby exposing the cavity 30 and the rear opening 34. When the rear opening 34 is exposed, or not covered by the closure portion 36, the camera 22 may be placed inside of the housing 20 (i.e., may be placed inside of the cavity 30 through the rear opening 34).

The main portion 28 and the closure portion 36 may then be closed, or securely attached, thereby enclosing or housing the camera 22 inside the housing 20. In some embodiments, as illustrated in FIG. 2, a depth of the camera 22 may be greater than the depth of the main portion 28 (e.g., in the third direction Z), such that the camera 22 extends beyond the main portion 28 and a portion of the camera body 26 extends through the rear opening 34. In other embodiments, the depth of the camera 22 in the third direction Z may correspond to the depth of the main portion 28 in the third direction Z, such that the camera 22 is fully accommodated by the cavity 30. However, in yet further embodiments, the depth of the camera 22 in the third direction Z may be less than the depth of the main portion 28 in the third direction Z.

In one or more embodiments, the main portion 28 and the closure portion 36 may be connected by the hinge 35. For example, the bottom wall 31 and the bottom portion of the edge portion 37 may be connected by the hinge 35. Accordingly, the main portion 28 and the closure portion 36 may be rotatable or pivotable about the hinge 35, thereby exposing or covering the cavity 30 and the rear opening 34. In one or more embodiments, the housing 20 may omit the hinge and the main portion 28 and the closure portion 36 may be completely separable. In one or more embodiments, the hinge 35 may facilitate rotation of the main portion 28 and the closure portion 36 about a top or a side of the housing 20.

The main portion 28 may include a latching member 66 (e.g., a top latch snap member) and the closure portion 36 may further include a complementary latching member 68 (e.g., a top latch post) that mates with the latching member 66. As such, when the housing 20 is in a closed position, the latching member 66 and the complementary latching member 68 may latch together. The latching member 66 and the complementary latching member 68 may be any suitable means for fastening, for example, a compression latch or an over-center clasp pivotally attached to the main portion 28 to engage a protrusion on the closure portion 36. In some embodiments, the housing 20 may omit the latching member 66 and the complementary latching member 68. For example, in one or more embodiments, the rib 33 and the groove 39 may essentially function as a latch and the latching member 66 and the complementary latching member 68 may be omitted.

In some embodiments, the main portion 28 and the closure portion 36 may be releasably attachable by a plurality of latching members 66, 68. For example, the top wall 29 may include a first latching member 66 and the first side wall may include a first complementary latching member 68, and the bottom wall 31 may include a second latching member 66 and the bottom portion of the edge portion 37 may include a second complementary latching member 68 that mates with the second latching member 66. In some embodiments, the housing 20 may include three, four, or more latching members 450. The latching members may be located on various walls (or sides) of the main portion 28 and the closure portion 36, and each side may include more than one latching member 66. For example, the top wall 29 may include a third latching member 66 and the top portion of the edge portion 37 may include a third complementary latching member 68 that mates with the third latching member 66. In one or more embodiments, the housing 20 may include the hinge 35, the first latching member 66 on the top wall 29, the first complementary latching member 68 on the top portion of the edge portion 37, the second latching member 66 on the top wall 29 and spaced apart from the first latching member 66, and the second complementary latching member 68 on the top portion of the edge portion 37, spaced apart from the first complementary latching member 68.

As illustrated in FIGS. 3, 8, 10 and 11B, in one or more embodiments of the present invention, the hinge 35 may be recessed into the housing such that an outer surface of the housing 20 and the hinge 35 are substantially flush. In other words, a bottom surface of the housing 20 (or an outer surface of the bottom wall 31 and an outer surface of the bottom portion of the edge portion 37) may be flat or substantially flat. As such, the bottom surface of the housing may be easily placed on a flat surface.

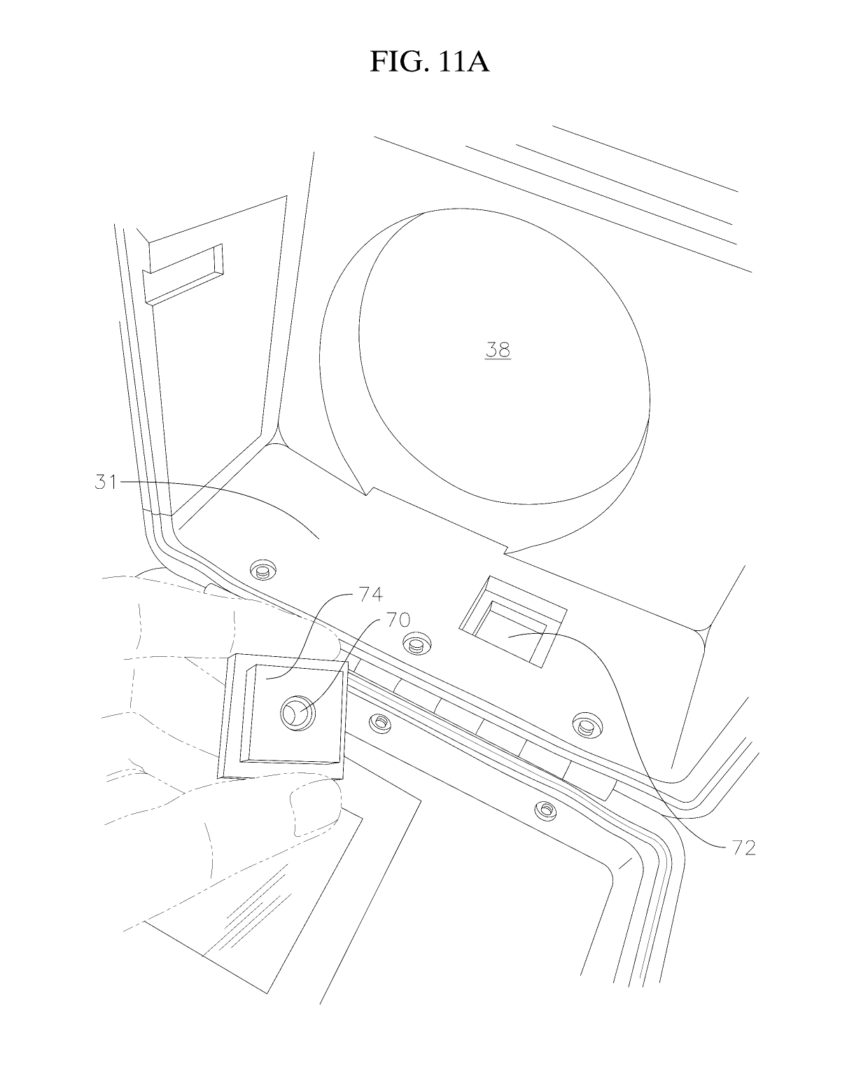

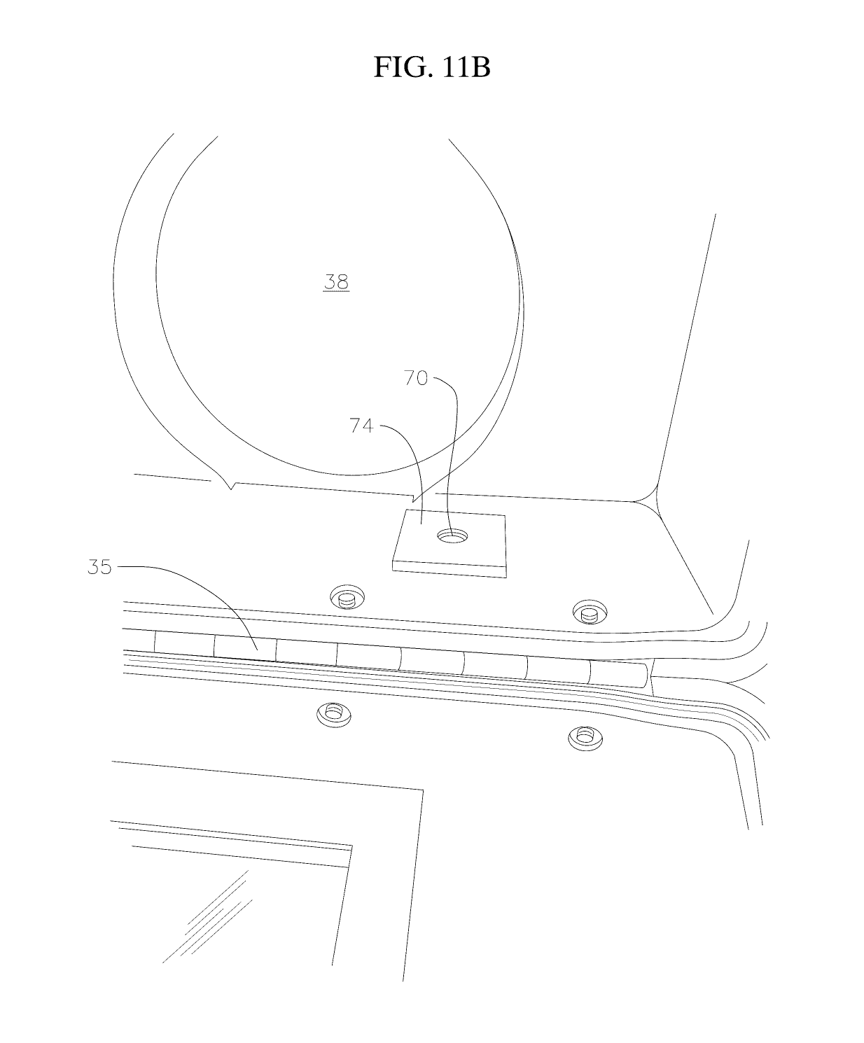

As illustrated in FIGS. 11A and 11B, the bottom surface may have a hole or recess 70. As an example, the recess 70 may be configured to accommodate a tripod or a camera strap. For example, the recess 70 may be a threaded opening or threaded hole that is configured to mate with a threaded peg on the tripod or on the camera strap. For example, the threaded opening may be threaded to accommodate a male connector having a 0.25″ diameter and 20 threads per inch. However, the shape of the recess 70 is not limited thereto, and may be any suitable shape such that the tripod, the camera strap, or another accessory may be attached to the bottom surface of the housing 20. In some embodiments, the housing 20 may omit the recess 70.

In one or more embodiments, the bottom wall 31 of the main portion 28 may have a bottom opening 72 that accommodates an adapter (e.g., a threaded adapter) 74, as illustrated in FIGS. 11A and 11B. The adapter 74 may include the recess 70, e.g., may include a threaded opening. In one or more embodiments, the adapter 74 is non-axisymmetric, and the corresponding bottom opening 72 is non-axisymmetric. For example, the bottom opening 72 may be stepped, such that a width in the first direction X and a length in the second direction Z of the bottom opening 72 at the outer surface of the bottom wall 31 is less than a width in the first direction X and a length in the second direction Z of the bottom opening 72 at an inner surface of the bottom wall 31. As such, the adapter 74 may be securely inserted into the bottom opening 72 without passing through the entire bottom opening 72. In one or more embodiments, the width and length of the bottom opening 72 at the outer surface of the bottom wall 31 (and a width and a length of the corresponding portion of the adapter 74) may be 0.75 inch and the width and length of the bottom opening 72 at the inner surface of the bottom wall 31 (and a width and length of the corresponding portion of the adapter 74) may be 1 inch. The dimensions of the bottom opening 72 may correspond to the dimensions of the adapter 74 such that the adapter 74 fits snugly into the bottom opening 72 and such that the adapter 74 and the opening 72 are firmly connected. The adapter 74 may have a thickness in the second direction Y that is the same or substantially the same as the thickness of the bottom wall 31. In one or more embodiments, the adapter 74 may be made of metal, for example, may be made of aluminum.

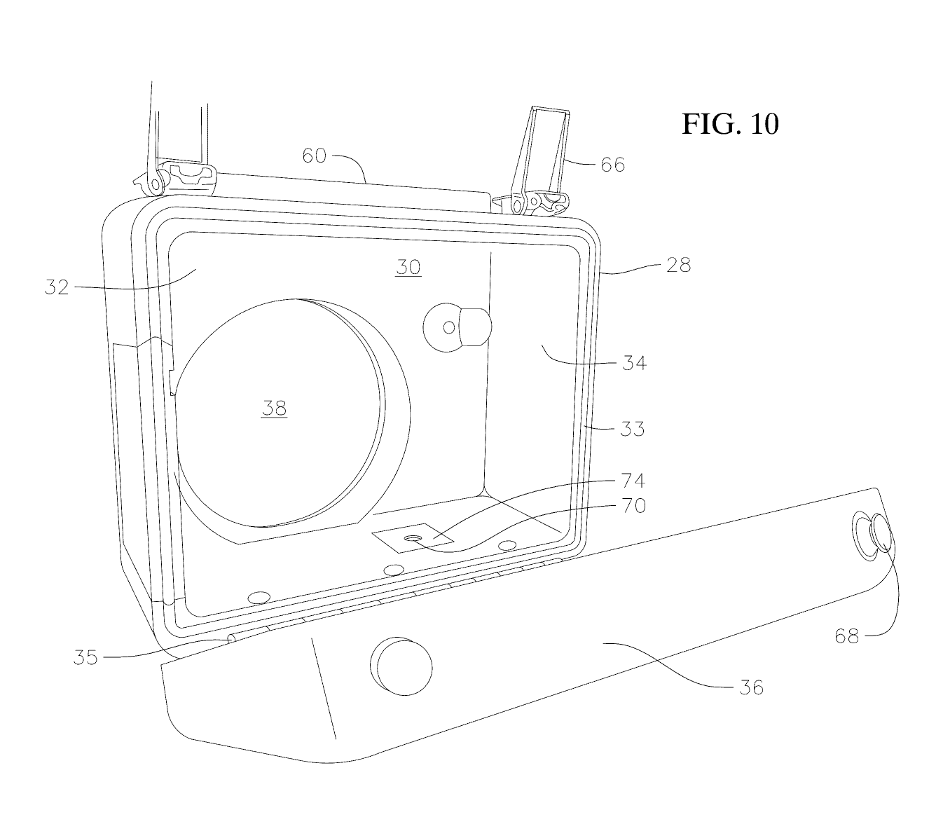

As illustrated in FIGS. 4 and 10, the main portion 28 may include the lens opening 38. More specifically, the lens opening 38 may be formed in the front wall 32 of the main portion 28. The lens opening 38 may be generally circular-shaped and may correspond to the lens 24 of the camera 22. However, the shape of the lens opening 38 is not limited thereto, and may be any suitable shape such that the lens 24 of the camera 22 may function properly. As illustrated in FIG. 1, the lens 24 of the camera 22 may extend through the lens opening 38.

The front wall 32 may further include a flange 50. For example, an outer surface of the front wall 32 may include the flange 50. The flange 50 may extend away from the housing 20 (e.g., may longitudinally extend from the outer surface of the front wall 32 in the third direction Z). The flange 50 may correspond to the lens opening 38 and may generally surround the lens opening 38. The flange 50 may be generally circular, but the present invention is not limited thereto, and the flange 50 may be any suitable shape such that the lens 24 of the camera 22 may function properly and/or may be inserted through the lens opening 38.

Referring to FIGS. 2 and 4, the flange 50 may be configured to receive a lens cover or a lens hood or lens tube 52. In one or more embodiments, the inner surface of the flange 50 may be tiered or stepped in the third direction Z, such that outer circumference of the flange 50 is substantially congruous and such that the flange 50 has a first inner circumference and a first thickness at a first portion adjacent the front wall 32, and a second thickness and a second inner circumference at a second portion adjacent an outer edge of the flange 50. To accommodate the lens hood or lens tube 52, the second inner circumference is greater than the first inner circumference (and the first thickness is greater than the second thickness). Accordingly, when the lens hood or lens tube 52 is inserted into the flange 50, the lens hood or lens tube 52 may abut the first portion of the flange 50 in the third direction Z. To secure the lens hood or lens tube 52, the housing 20 may include one or more retainers 51 (e.g., one or more lens tube retainers). In some embodiments, the housing 20 may include a first retainer 51, a second retainer 51, and a third retainer 51. However, fewer or more than three retainers 51 may be used.

The retainers 51 may be attached to the outer edge of the flange 50 (i.e., the flange 50 may be between the retainers 51 and the housing 20). Each retainer 51 may be rotatable about an axis extending in the third direction Z. In one or more embodiments, the retainer 51 may have a flat outer surface, a flat inner surface adjacent the flange 50, three flat side surfaces, and a curved side surface. The curved side surface may be defined by an arcuate groove that provides a relatively simple interface between a user's finger and the retainer 51 so that a user may easily rotate or pivot the retainers 51. However, the shape of the retainers 51 is not limited thereto, and the retainers 51 may have any suitable shape. The retainers 51 may each be aligned on the flange 50 such that in a first orientation, one of the three flat side surfaces does not overlap with the lens opening 38, and in a second orientation, at least a portion of the retainer 51 overlaps with the lens opening 38, thereby securing the lens hood or lens tube 52 to the flange 50, and minimizing the likelihood of the lens hood or lens tube 52 becoming separated from the flange 50.

In one or more embodiments, the flange 50 further includes the notch 54. As illustrated in FIG. 4, the notch 54 may be formed in a lower portion of the flange 50. The notch 54 may be formed in the lower portion of the flange 50 to prevent the flange 50 from extending beyond the bottom surface of the housing 20 in the second direction Y. Without the notch 54, the flange 50 may extend beyond the bottom surface of the housing 20 in the second direction Y, or additional material may be needed to increase the thickness of the bottom surface of the housing 20, which may result in a heavier and more expensive to manufacture design. As such, the notch 54 allows for a more compact housing 20 that may still easily accommodate the lens hood or lens tube 52 or a lens cap and that may still rest level on a flat surface. The notch 54 may be any suitable shape or depth such that the lens hood or lens tube 52 or the lens cap may be accommodated in the housing 20.

Referring to FIGS. 1 and 4, the main portion may include the shutter trigger assembly 56 that engages a shutter release on the camera body 26. The shutter trigger assembly 56 may include a shutter trigger (or head) 57 and the shaft 58. The shutter trigger assembly 56 may be aligned in a shutter through-hole formed in the front wall 32. The shaft 58 may be positioned inside the shutter through-hole and the shutter trigger 57 of the shutter trigger assembly 56 may be positioned outside of the outer surface of the front wall 32. When a user depresses the shutter trigger 57 (e.g., applies pressure in the first direction X toward the housing 20), the shaft 58 moves or slides within the shutter through-hole to engage the shutter release on the camera body 26. The shaft 58 and the shutter through-hole may be sized such that the shaft 58 readily slides within the through-hole but also so that substantially no gap exists between an outer diameter of the shaft 58 and an inner diameter of the through-hole.

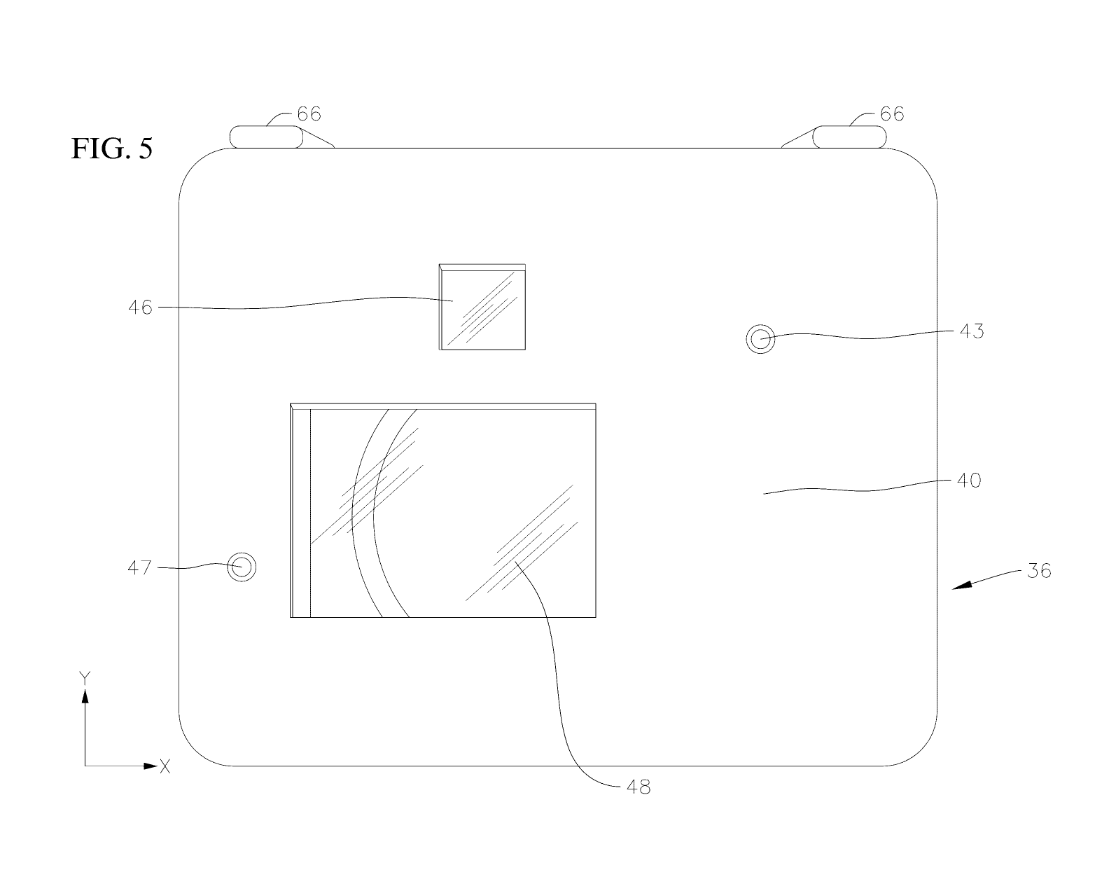

Referring to FIGS. 5 and 9, the closure wall 40 may include the first protrusion 42. The first protrusion 42 may correspond to an autofocus button, or other similar button on the camera body 26. The first protrusion 42 may protrude from an inner surface of the closure wall 40 and toward the cavity 30 when the housing 20 is in the closed configuration. The first protrusion 42 may be formed in a portion of the closure wall 40 that is thinner and more deformable relative to the adjacent portions of the closure wall 40 to facilitate actuating the autofocus button by depressing the portion of the closure wall 40 having the first protrusion 42. For example, the first protrusion 42 may be surrounded by a first protrusion groove 41. In one or more embodiments, the first protrusion 42 may be substantially cylindrical with a rounded head that may engage a button on the camera body 26, and the first protrusion groove 41 may be a circumferential groove surrounding the first protrusion 42. However, the present invention is not limited thereto, and the first protrusion 42 and the first protrusion groove 41 may be any suitable shape such that the first protrusion 42 may be moved to contact the button on the camera body 26. Because the first protrusion 42 is surrounded by the first protrusion groove 41, a thickness of the closure wall 40 in the area surrounding the first protrusion 42 is less than a thickness of the closure wall 40 in other areas of the closure wall 40. As such, the first protrusion 42 may be easily movable in a thickness direction of the closure wall 40 (e.g., in the third direction Z when the housing 20 is in the closed configuration). In one or more embodiments, a first portion of the closure wall 40 may be formed of a relatively smaller thickness to allow for improved flexibility of an area surrounding the first protrusion 42. As such, when a user applies pressure to an outer surface of the closure wall 40 at the first portion, and in particular in the area corresponding to the first protrusion 42, the first protrusion 42 may move further into the cavity 30, thus engaging the button on the camera body 26. In one or more embodiments, the outer surface of the closure wall 40 may include a first protuberance 43 that corresponds to the first protrusion 42. As such, a user may apply pressure to the first protuberance 43 to push the first protrusion 42 into the cavity 30.

In one or more embodiments, the closure wall 40 may include the second protrusion 44. The second protrusion 44 may correspond to a navigation button or other button on the camera body 26. Much like the first protrusion 42, the second protrusion 44 may protrude from the inner surface of the closure wall 40 and toward the cavity 30 when the housing 20 is in the closed configuration. The second protrusion 44 may be surrounded by a second protrusion groove 45. The outer surface of the closure wall 40 may include a second protuberance 47 that corresponds to the second protrusion 44. The same principles discussed above with reference to the first protrusion 42 may be applied to the second protrusion 44, so additional description of the second protrusion 44 is omitted herein.

Referring to FIG. 5, the closure portion 36 may include the viewfinder window 46. For example, the closure wall 40 may have a viewfinder opening defined in a portion thereof. The viewfinder window 46 may be transparent or substantially transparent and may be inserted into the viewfinder opening of the closure wall 40. The viewfinder window 46 may be positioned such that when the camera 22 is inserted into the housing 20, a viewfinder on the camera body 26 aligns with the viewfinder window 46. As such, a user may utilize the viewfinder on the camera body 26 while the camera 22 is inside the housing 20. The viewfinder window 46 may be made of any suitable material, for example may be made of clear or transparent polycarbonate.

Also referring to FIG. 5, the closure portion 36 may include the screen window 48. For example, the closure wall 40 may have a screen opening defined in a portion thereof. The screen window 48 may be transparent or substantially transparent and may be inserted into the screen opening of the closure wall 40. The screen window 48 may be positioned such that when the camera 22 is inserted into the housing 20, a screen (for example an LCD screen) on the camera body 26 aligns with the screen window 48. As such, a user may view the screen on the camera body 26 while the camera 22 is inside the housing 20. The screen window may be made of any suitable material, for example may be made of clear or transparent polycarbonate.

In one or more embodiments, the housing 20 may include the screen window 48 and the second protrusion 44. The second protrusion 44 may be positioned adjacent the screen window 48 so that the second protrusion 44 may be used to engage a navigation button adjacent a screen of the camera 22.

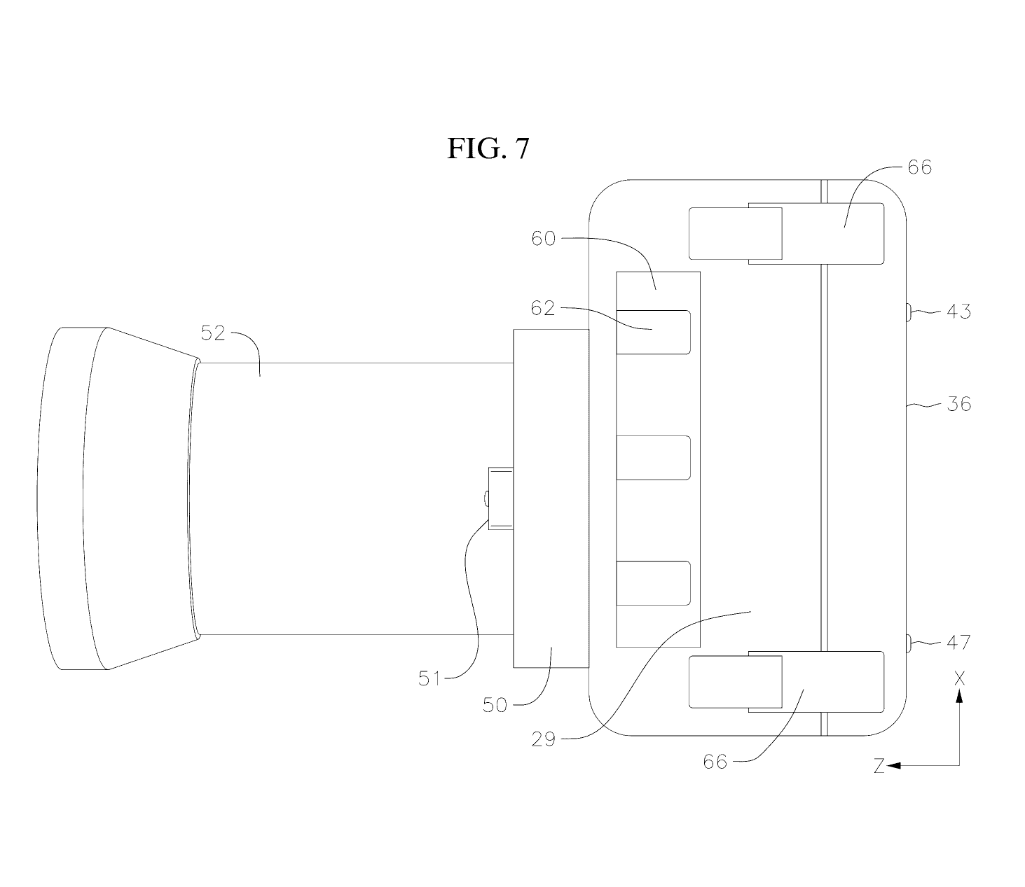

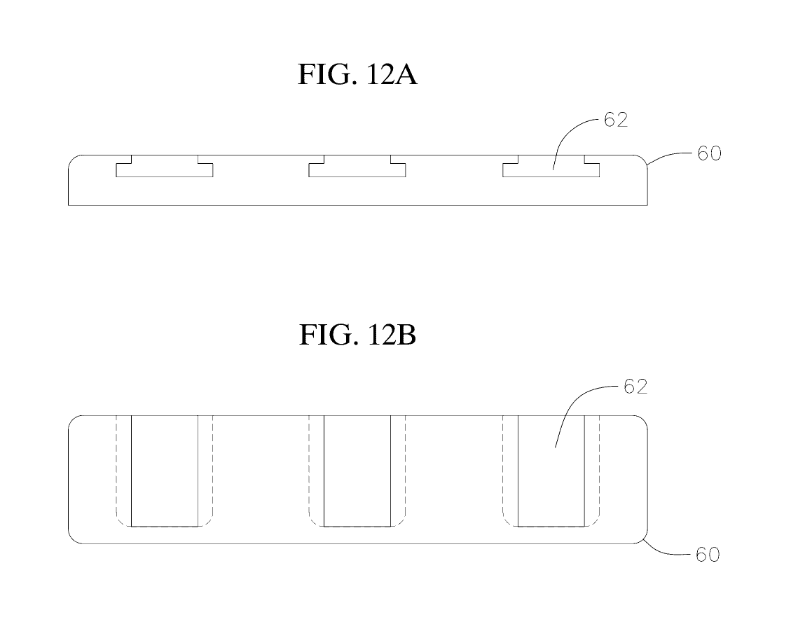

In one or more embodiments, the housing 20 may include the utility bar 60. For example, the utility bar 60 may be mounted onto the top wall 29 of the main portion 28, as illustrated in FIG. 7. Referring to FIGS. 7, 12A and 12B, the utility bar 60 may include one or more slits or shoes 62. The shoes 62 may be configured to hold various camera accessories, for example, to hold a lens shade, a French Flag, a mounted GOPRO, etc. The shoes 62 may be defined in an upper portion of the utility bar 60.

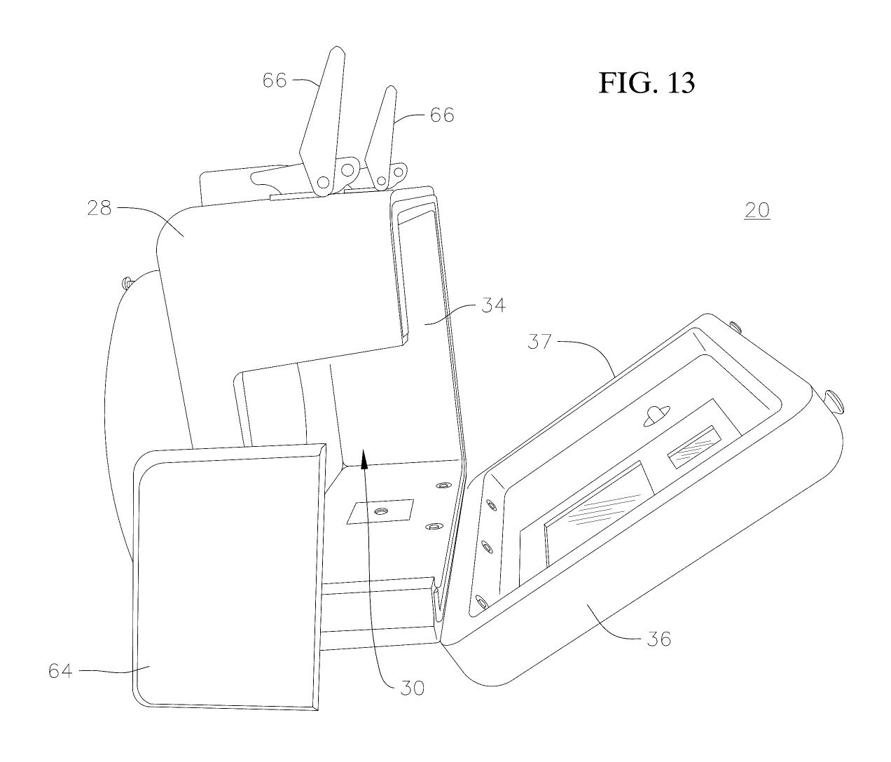

Referring to FIG. 13, in one or more embodiments, the housing 20 may include the removable side panel 64. The side panel 64 may be removable from the housing 20 to expose the cavity 30, or to expose a side of the camera body 26 when it is inside the housing 20. The side panel 64 may have a quadrilateral shape. For example, the side panel 64 may have a rectangular, a trapezoidal, or any suitable shape. In some embodiments, the side panel 64 may be triangular or may be arcuate. In some embodiments, the side panel 64 may have rounded edges and in other embodiments the side panel 64 may have pointed edges. An outer surface of the side panel 64 may further include a side panel groove to facilitate removal of the side panel 64.

When the side panel 64 is removed from the housing 20, a user may access the side of the camera body 26, thereby allowing the user to attach various cables to the camera body 26, for example audio/visual cables. Although the side panel 64 is referred to as a “side” panel, the side panel 64 may be located in any suitable wall of the housing 20 such that it corresponds to a portion of the camera body 26 to which audio/visual cables and other cables may be attached.

In one or more embodiments, the housing 20 may include a material inside the housing 20 to support and to snugly align the camera body 26 inside the housing 20. For example, the housing 20 may include one or more pieces of a foam material affixed to an inner surface of the front wall 32 inside the cavity 30. The material may provide additional sound dampening qualities, and may help to properly align the camera body 26 once it has been inserted into the rear opening 34. For example, the material may extend in the third direction Z and may prevent the camera body 26 from contacting the front wall 32, thereby improving the likelihood that the camera body 26 is properly aligned in the housing 20, and allowing a user to utilize various features of the housing 20, for example, to utilize the first protrusion 42 even if a user decides to point the housing 20 with the camera 22 in a downward direction.

The figures depict some example embodiments as applied to a sound blimp for illustrative purposes only, and it will be apparent that modifications may be made without departing from the spirit and scope of the invention, and also that the present disclosure may be used in other applications in the same or similar fields. Although relative terms such as “first,” “second,” “third,” “fourth,” “top,” “bottom,” “right,” “left,” “length,” “width,” “depth” and similar terms have been used herein to describe relative spatial relationships between elements, it is to be understood that these terms are intended to encompass different orientations of the various elements and components of the device in addition to the orientation depicted in the figures. Moreover, the figures contained in this application are not necessarily to scale.

As used herein, the terms “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” In addition, the use of alternative language, such as “or,” when describing embodiments of the present invention, refers to “one or more embodiments of the present invention” for each corresponding item listed. As used herein, the terms “use,” “using,” and “used” may be considered synonymous with the terms “utilize,” “utilizing,” and “utilized,” respectively. Also, the term “exemplary” is intended to refer to an example or illustration.

It will be appreciated by persons skilled in the art that the features described herein may be used alone or in combination and remain within the spirit and scope of the present disclosure.

While this disclosure has been described in detail with particular references to some exemplary embodiments thereof, the exemplary embodiments described herein are not intended to be exhaustive or to limit the scope of the disclosure to the exact forms disclosed. Persons skilled in the art and technology to which this disclosure pertains will appreciate that alterations and changes in the described structures and methods of assembly and operation can be practiced without meaningfully departing from the principles, spirit, and scope of this disclosure, as set forth in the following claims and their equivalents.

What is claimed is:

1. A housing for operating a camera having a camera lens and a camera body, the housing comprising:
a main portion defining a cavity for receiving the camera body, the main portion having a front wall and a rear opening; and
a closure portion releasably connected to the main portion to close the rear opening,
wherein the front wall has a lens opening for receiving the camera lens when the camera is within the cavity of the main portion, and
wherein the housing comprises a homogeneous mass of rubber material.

2. The housing of claim 1 wherein the front wall has a thickness of between about ⅛ inch and about 1 inch.

3. The housing of claim 1 wherein the material of the housing is an ethylene propylene diene monomer (EPDM) rubber.

4. The housing of claim 1, wherein the closure portion comprises:
a closure wall; and
a peripheral portion extending around the perimeter of the closure wall and away from the closure wall in a direction perpendicular to the closure wall.

5. The housing of claim 4,
wherein the main portion comprises a top wall, a bottom wall, and two side walls, each comprising a first profiled edge portion, and
wherein the peripheral portion of the closure wall comprises a second profiled edge portion, wherein the first profiled edge portion is complementary to the second profiled edge portion.

6. The housing of claim 5 wherein one of the first and second profiled edge portions is a rib and the other of the first and second profiled edge portions is a groove.

7. The housing of claim 1 wherein the main portion and the closure portion are connected by a hinge.

8. The housing of claim 7 wherein the hinge is recessed into the housing.

9. The housing of claim 1 further comprising a recess in a bottom surface of the housing.

10. The housing of claim 9 wherein the recess comprises a threaded opening.

11. The housing of claim 9 further comprising a non-axisymmetric threaded adapter sized to fit inside the recess of the housing.

12. The housing of claim 1 further comprising a flange surrounding the lens opening and extending away from the housing.

13. The housing of claim 12, wherein the flange comprises a notch in a lower portion thereof.

14. The housing of claim 12 further comprising one or more retainers connected to the flange and configured to maintain contact between a lens hood and the flange.

15. The housing of claim 1 wherein the main portion further comprises a shutter through-hole and the housing further comprises a shutter button configured to engage a shutter release on the camera.

16. The housing of claim 1 wherein the closure wall further comprises a first protrusion protruding from an inner surface of the closure wall to engage a first button on the camera body when the camera is in the housing and when the rear opening is closed.

17. The housing of claim 16 wherein the closure wall further comprises a second protrusion protruding from an inner surface of the closure wall to engage a second button on the camera body when the camera is in the housing and when the rear opening is closed.

18. The housing of claim 16 wherein a portion of the closure wall surrounding the first protrusion is thinner than adjacent portions of the closure wall.

19. The housing of claim 1 wherein the main portion comprises a top wall having a utility bar connected thereto.

20. The housing of claim 1 wherein the main portion comprises a slidable side panel that is removable to expose a side of the camera body when the camera is in the housing and when the rear opening is closed.
